(19) United States
(12) Patent Application Publication
(10) Pub. No.: US 2012/0319549 A1
(43) Pub. Date: Dec. 20, 2012

(54) ROLLER MOUNT FOR DRAWER GLIDE MECHANISM

(75) Inventor: Jeffrey Scott Hoeft, Laguna Hills, CA (US)

(73) Assignee: RSI HOME PRODUCTS MANAGEMENT, INC., Anaheim, CA (US)

(21) Appl. No.: 13/526,285

(22) Filed: Jun. 18, 2012

Related U.S. Application Data
(60) Provisional application No. 61/499,090, filed on Jun. 20, 2011.

(51) Int. Cl. A47B 88/14; B23P 11/00

(52) U.S. Cl. 312/334.12; 29/525.03

(57) ABSTRACT

A drawer glide mechanism includes an elongate guide member, a roller mounted to the guide member, the roller mounted about a hollowed out rivet, and a fastener extending through the hollowed out interior of the rivet, through at least a portion of the guide member, and into the drawer, thereby securing at least the roller to the drawer in a supported and stable manner.

### CROSS-REFERENCE TO RELATED APPLICATIONS

This application claims benefit under 35 U.S.C. §119(e) to U.S. Provisional Patent Application No. 61/499,090, filed Jun. 20, 2011, which is incorporated in its entirety by reference herein.

### BACKGROUND OF THE INVENTIONS

1. Field of the Inventions

The present application relates generally to drawer glide mechanisms, and specifically to improved roller mounts for drawer glide mechanisms.

2. Description of the Related Art

Drawer glide mechanisms (sometimes referred to as drawer slides) commonly include an elongate guide member. The elongate guide member is typically an elongate metal piece mounted to the side of a drawer, and is used to help guide the drawer in and out of a base shelving unit (e.g. a desk). Typically the drawer glide mechanism includes at least one roller (e.g. wheel) mounted on the elongate guide member. The roller is used to allow the drawer to slide in and out of the base shelving unit, along for example, a complementary guide located within the base shelving unit.

Some manufacturers mount their elongate guide members directly to the drawer with screws or other fasteners, for example by inserting screws through the metal guide member in one or more locations. In order to avoid costs and time, some manufacturers mount their guide members to the drawer instead by crimping at least a portion of the elongate guide member to the drawer, or to some component on the outside of the drawer.

### SUMMARY OF THE INVENTION

An aspect of at least one of the embodiments disclosed herein includes the realization that it would be advantageous to have a structure or mechanism by which the guide member and/or roller can be quickly and efficiently attached to a drawer, while at the same time held in place such that the elongate guide member and/or roller is in a stable, supported position.

Thus, in accordance with at least one embodiment described herein, a drawer glide mechanism (e.g. drawer slide) can comprise an elongate guide member, a roller mounted to the guide member, the roller mounted about a hollowed out rivet, and a fastener extending through the hollowed out interior of the rivet, through at least a portion of the guide member, and further into the drawer itself, thereby securing at least the roller to the drawer in a supported and stable manner.

### BRIEF DESCRIPTION OF THE DRAWINGS

These and other features and advantages of the present embodiments will become more apparent upon reading the following detailed description and with reference to the accompanying drawings of the embodiments, in which:

FIG. 1 is a partial schematic front side view of a drawer glide mechanism in accordance with an embodiment, illustrating an elongate guide member, roller, and rivet;

FIG. 2 is a partial schematic front side view of the drawer glide mechanism of FIG. 1;

FIG. 3 is a partial schematic bottom plan view of the drawer glide mechanism of FIG. 1;

FIG. 4 is a partial schematic bottom plan view of the drawer glide mechanism of FIG. 1, illustrating a fastener being inserted through the rivet;

FIG. 4A is a partial schematic bottom plan view of the drawer glide mechanism of FIG. 1, illustrated a fastener after inserted through the rivet;

FIG. 5 is a schematic top side view of the fastener from FIG. 4;

FIG. 6 is a partial schematic perspective view of a drawer glide mechanism in accordance with an embodiment;

FIGS. 7 and 8 are exploded views of the drawer glide mechanism of FIG. 6; and

### DETAILED DESCRIPTION OF THE PREFERRED EMBODIMENTS

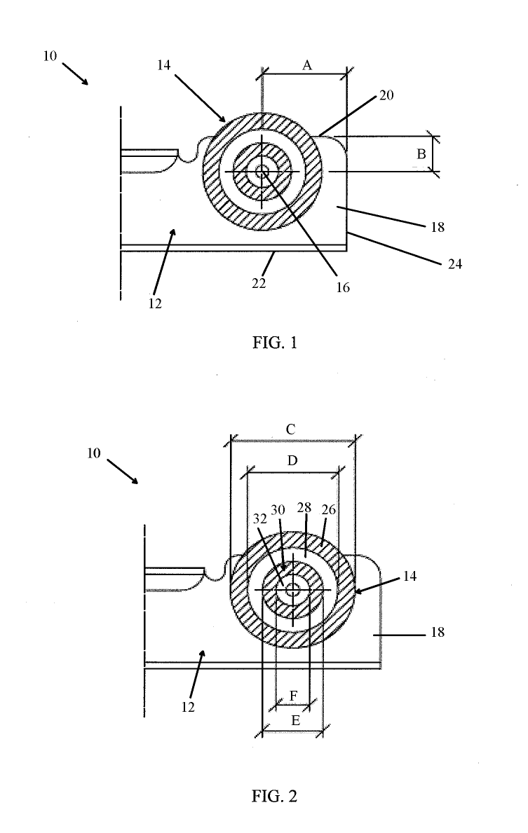

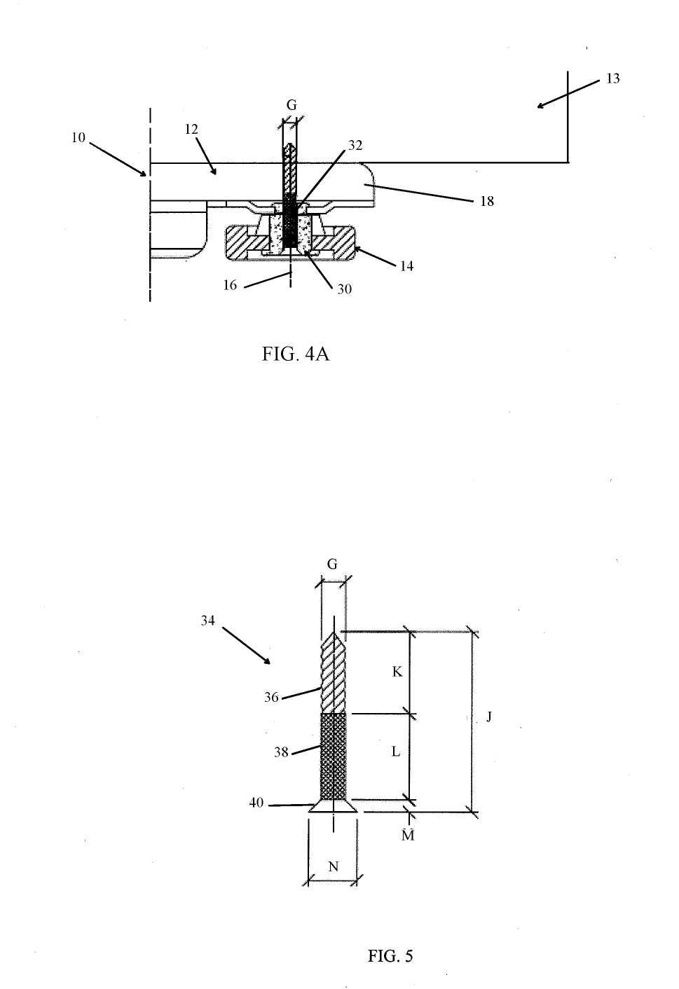

With reference to FIGS. 1-4, a drawer glide mechanism 10 can comprise an elongate guide member 12. The elongate guide member 12 can comprise an elongate piece of metal configured to be attached to the side of a drawer 13. The guide member 12 can help to guide a drawer as the drawer glides in and out of a base shelving unit (e.g. a desk or other structure).

The drawer glide mechanism 10 can comprise at least one roller 14. The roller 14 can comprise a wheel, or other structure, which facilitates rolling or gliding movement of the drawer, e.g. within a base shelving unit. The roller 14 can rotate, for example, about a central axis 16.

With reference to FIG. 1, the roller 14 can be mounted to the elongate guide member 12 at a distal end portion 18 of the elongate guide member 12. The distal end portion 18 can include a top surface 20 and a bottom surface 22, as well as a distal edge 24. The roller 14 can be mounted such that there is a distance A between the central axis 16 and the distal edge 24. In some embodiments the distance A is between approximately 12 and 14 mm, though other values and ranges are also possible. For example, in some embodiments the distance A can range between approximately 11 and 15 mm. In some embodiments the distance A can be approximately 14 mm. The roller 14 can also be mounted so that there is a distance B between the central axis 16 and the top surface 20. In some embodiments the distance B is between approximately 4.5 and 6.5 mm, though other values and ranges are also possible. For example, in some embodiments the distance B can range between approximately 4 and 7 mm. In some embodiments the distance B can be approximately 5 mm.

With reference to FIG. 2, the roller 14 can include an outer portion 26 having an outer diameter C, and an inner diameter D. In some embodiments the outer diameter C can range between approximately 18 and 19 mm, though other values and ranges are also possible. For example, in some embodiments the outer diameter C can range between approximately 17 and 20 mm. In some embodiments the outer diameter C can be approximately 18.4 mm. In some embodiments the inner diameter D can range between approximately 13 and 14 mm, though other values and ranges are also possible. For example, in some embodiments the inner diameter D can range between approximately 12 and 15 mm. In some embodiments the inner diameter D can be approximately 13.4 mm.

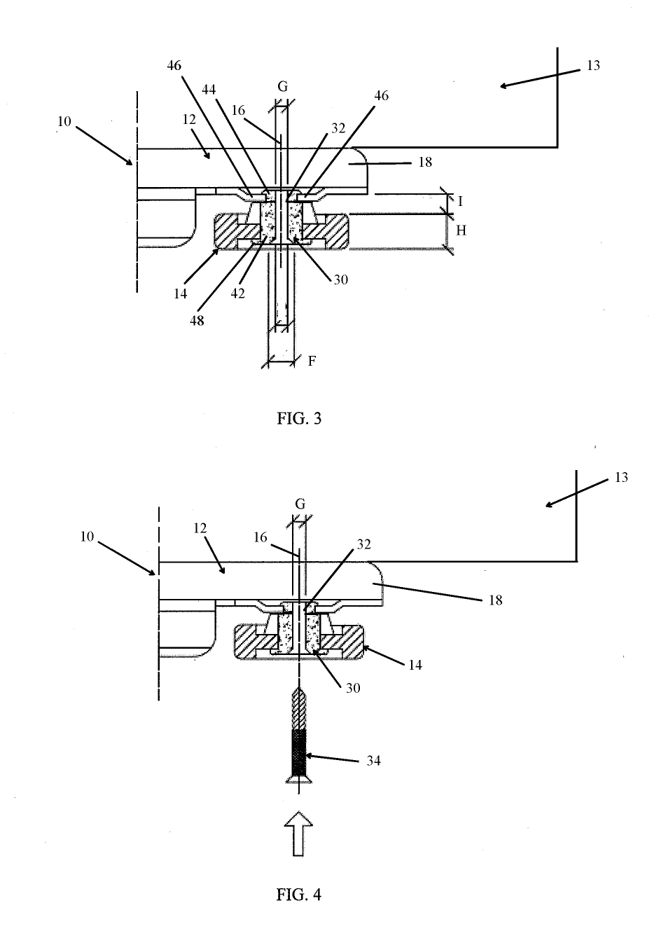

With reference to FIGS. 2 and 3, the roller 14 can include a hollowed out section 28. The hollowed out section 28 can be formed so that a rivet 30 can be inserted through the roller 14. The rivet 30 can have an outer diameter E. In some embodiments the outer diameter E can range between approximately 8.5 and 9.5 mm, though other values and ranges are also possible. For example, in some embodiments the outer diameter E can range between approximately 8 and 10 mm. In some embodiments the outer diameter E can be approximately 9 mm. The rivet 30 can also have a first inner diameter F. The first inner diameter F can range between approximately 4.5 and 5.5 mm, though other values and ranges are also possible. For example, in some embodiments the inner diameter F can range between approximately 4 and 6 mm. In some embodiments the first inner diameter F can be approximately 5 mm.

With continued reference to FIGS. 2 and 3, the rivet 30 can comprise a through hole 32 having a second inner diameter G. As illustrated in FIG. 3, the second inner diameter G can extend through the rivet 30. In some embodiment the second inner diameter G can range between approximately 1.8 and 2.2 mm, though other values and ranges are also possible. For example, in some embodiments the second inner diameter G can range between approximately 1.6 and 2.4 mm. In some embodiments the second inner diameter G can be approximately 2.0 mm.

With continued reference to FIG. 3, at least a portion of the roller 14 can have a width H. The width H can range between approximately 4 and 6 mm, though other values and ranges are also possible. For example, in some embodiments the width H can range between approximately 3 and 7 mm. In some embodiments the width H can be approximately 5 mm. In some embodiments, the rivet 30 can extend beyond the portion of the roller 14 having width H by a distance I. In some embodiments the distance I can range between approximately 2.8 and 3.2 mm, though other values and ranges are also possible. For example, in some embodiments the distance I can range between approximately 2.6 and 3.4 mm. In some embodiments the distance I can be approximately 3 mm.

With reference to FIGS. 3-5, a fastener 34 can be inserted through the through hole 32, into the elongate guide member 12, and further into the drawer 13. The fastener 34 can comprise, for example, a screw. In some embodiments the fastener 34 can have a diameter G that generally matches the diameter of the through hole 32. The fastener 34 can have a length J that is between approximately 14 and 16 mm, though other values and ranges are also possible. For example, in some embodiments the fastener 34 can have a length J that is between approximately 13 and 17 mm. In some embodiments the length J can be approximately 15 mm. The fastener 34 can include an interlocking portion configured to secure the guide to the drawer, such as threaded portion 36, having a length K. The length K can range between approximately 6 and 7 mm, though other values are also possible. For example, in some embodiments the length K can range between approximately 5 and 8 mm. In some embodiments the length K can be approximately 6.8 mm. The fastener 34 can also include a support portion which is configured to cooperate with the rivet to support the roller, such as non-threaded portion 38, having a length L. The length L can range between approximately 7 and 8 mm, though other values and ranges are also possible. For example, in some embodiments the length L can range between approximately 6 and 9 mm. In some embodiments the length L can be approximately 7.2 mm. The fastener 34 can also include a head 40, having a length M. The length M can range between approximately 0.9 and 1.1 mm, though other values and ranges are also possible. For example, in some embodiments the length M can range between approximately 0.8 and 1.2 mm. In some embodiments the length M can be approximately 1 mm. The head 40 can have a width N. The width N can range between approximately 3 and 5 mm, though other values and ranges are also possible. For example, in some embodiments the width N can range between approximately 2 and 6 mm. In some embodiments the width N can be approximately 4 mm. The end of the fastener 34 opposite the head 40 can define an assembly aide, such as a pointed end, to facilitate insertion of the fastener into a wall of a drawer.

With reference to FIG. 3, in order to assemble the rivet 30 onto the drawer glide mechanism 10, a traditional riveting process can be used. For example, the rivet 30 can initially comprise two elongate cylindrical portions, a front portion 42 and a tail portion 44. The front portion 42 can be inserted through a central opening in the roller 14. The tail portion 44 of the rivet 30 can be inserted through a slightly smaller hole in a raised section 44 of the guide member 12. The tail portion 44 can then be deformed (as seen in FIG. 3) to hold the rivet 30 in place (i.e. creating the sandwiched appearance around the two raised portions 46 shown in FIG. 3). The rivet 30 can further include a head portion 48 which rests against or near the roller 14, thereby helping to hold the roller 14 in place in a stable manner relative the guide member 12. In some embodiments the head portion 48 can have a diameter larger than the front portion 42, and the front portion 42 can have a diameter larger than the tail portion 44.

Incorporating a fastener 34 that extends through a rivet and roller, through a guide member, and into a drawer, can provide added stability and support for a drawer glide mechanism like drawer glide mechanism 10. For example, the fastener 34 can provide added stability and support for the elongate guide member 12, and/or the roller 14. By using a rivet 30, or other structure that includes a hollowed out portion for receiving the fastener 34, the material costs for the rivet 30 can be reduced, since less material for the rivet 30 is needed than if there were no hollowed out portion (e.g. through hole 32) in the rivet 30. At the same time, the roller 14 can be held more firmly in place than if it did not have the support of the fastener 34. Use of the rivet 30 and fastener 34 can be particularly advantageous when the elongate support member 12 is generally attached to the drawer without the use of fasteners. For example, and as described above, some manufacturers sometimes crimp one or more portions of an elongate guide member to attach it to a drawer. While this can achieve attachment, it may not always provide the type of support and stability desired. Therefore, by adding a feature or features for mounting the roller, like the rivet 30 and fastener 34 described above, a manufacturer can continue to quickly and efficiently assemble a drawer, while maintaining the type of support and stability desired for the roller 14 and/or elongate guide member 12.

Similarly, incorporating a rivet that is secured to the guide member 12, as well as to the roller 14 through a traditional riveting process, adds further stability. The overall stability and ease of assembly of the glide mechanism 10 described above therefore makes it an advantageous alternative to current glide members.

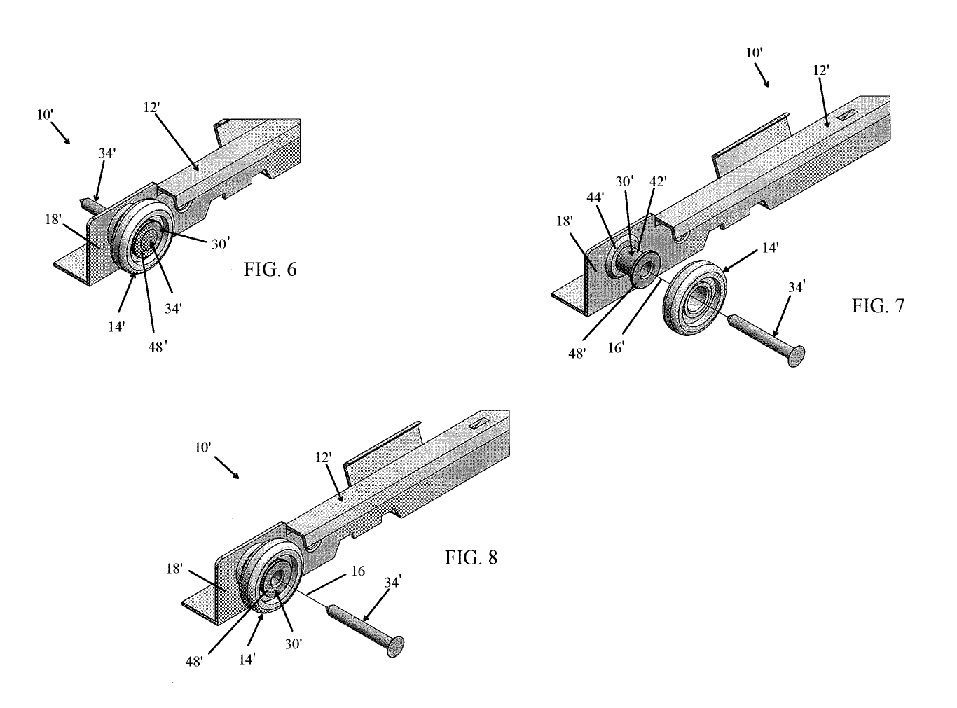

FIGS. 6-8 illustrate another drawer glide mechanism 10′. The drawer glide mechanism 10′ can be similar to the drawer glide mechanism 10. For example, the drawer glide mechanism 10′ can include an elongate member 12′ with a distal end 18′. The drawer glide mechanism 10′ can further include a raised portion 44′, through which at least a portion of a rivet 30′ extends. The drawer glide mechanism 10′ can further include a roller 14′ with an opening through which both a fastener 34′ and at least a portion of the rivet 30′ extends, the roller 14′ configured to rotate about a central axis 16′. Similarly, the rivet 30′ can include a head portion 48′, as well as a front portion 42′ and tail portion (not shown). As illustrated, the drawer glide mechanisms 10, 10′ can differ in certain aspects including dimensions and/or shape (e.g. shape or dimension of the guide member 12, 12′). Overall, however, the drawer glide mechanisms 10, 10′ can provide efficiency in terms of assembly and cost, and can provide structural stability to an overall shelving system.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combinations or sub-combinations of the specific features and aspects of the embodiments can be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A drawer assembly comprising:
a drawer;
a drawer glide mechanism attached to the drawer, the drawer glide mechanism comprising:
an elongate guide member;
a rivet attached to the guide member, the rivet having an opening extending therethrough, a central axis extending through the opening;
a roller attached to the rivet and configured to rotate about the central axis; and
a fastener extending through opening of the rivet and into the drawer.

2. The drawer assembly of claim 1, wherein the rivet comprises a head portion, a front portion, and a tail portion, the head portion having a diameter larger than the front portion, and the front portion having a diameter larger than the tail portion.

3. The drawer assembly of claim 2, wherein the roller comprises a hollowed out portion, the head portion of the rivet positioned within the hollowed out portion.

4. The drawer assembly of claim 2, wherein the front portion of the rivet extends through a central opening in the roller.

5. The drawer assembly of claim 2, wherein the elongate guide member comprises a raised portion at the distal end, the tail portion of the rivet extending through an opening formed by the raised portion.

6. The drawer assembly of claim 2, wherein the diameter of the head portion of the rivet is larger than the diameter of the opening extending through the rivet.

7. The drawer assembly of claim 1, wherein the elongate guide member comprised of metal.

8. The drawer assembly of claim 1, wherein the opening extending through the rivet has a diameter ranging between approximately 1.8 and 2.2 mm.

9. The drawer assembly of claim 1, wherein the roller has an outer diameter that ranges between approximately 18 and 19 mm.

10. The drawer assembly of claim 1, wherein the fastener comprises a screw having a length between approximately 14 and 16 mm.

11. A drawer glide mechanism comprising:
an elongate guide member;
a rivet attached to the guide member, the rivet having an opening extending therethrough, a central axis extending through the opening;
a roller attached to the rivet and configured to rotate about the central axis; and
a fastener extending through opening of the rivet and configured to secure the guide mechanism to a drawer.

12. The drawer glide mechanism of claim 11, wherein the rivet comprises a head portion, a front portion, and a tail portion, the head portion having a diameter larger than the front portion, and the front portion having a diameter larger than the tail portion.

13. The drawer glide mechanism of claim 12, wherein the roller comprises a hollowed out portion, the head portion of the rivet positioned within the hollowed out portion.

14. The drawer glide mechanism of claim 12, wherein the front portion of the rivet extends through a central opening in the roller.

15. The drawer glide mechanism of claim 12, wherein the elongate guide member comprises a raised portion at the distal end, the tail portion of the rivet extending through an opening formed by the raised portion.

16. The drawer glide mechanism of claim 12, wherein the diameter of the head portion of the rivet is larger than the diameter of the opening extending through the rivet.

17. The drawer glide mechanism of claim 11, wherein the elongate guide member comprised of metal.

18. The drawer glide mechanism of claim 11, wherein the opening extending through the rivet has a diameter ranging between approximately 1.8 and 2.2 mm.

19. The drawer glide mechanism of claim 11, wherein the roller has an outer diameter that ranges between approximately 18 and 19 mm.

20. A method of attaching a drawer glide mechanism to a drawer comprising:
providing a drawer
providing a drawer glide mechanism to be attached to the door, the drawer glide mechanism comprising:
an elongate guide member;
a rivet having an opening extending therethrough, a central axis extending through the opening;
a roller configured to rotate about the central axis, the roller having a hollowed out portion; and
a fastener;
inserting the rivet through the hollowed out portion of the roller;
attaching the rivet to the elongate guide member; and
inserting the fastener through the opening of the rivet, through the elongate guide member, and into the drawer;
